(19) United States
(12) Patent Application Publication
(10) Pub. No.: US 2014/0188861 A1
(43) Pub. Date: Jul. 3, 2014

(54) USING SCIENTIFIC PAPERS IN WEB SEARCH

(71) Applicant: GOOGLE INC., (US)

(72) Inventors: Michael Angelo, San Francisco, CA (US); Andrew Tomkins, San Jose, CA (US); Benedict A. Gomes, Mountain View, CA (US)

(73) Assignee: GOOGLE INC., Mountain View, CA (US)

(21) Appl. No.: 13/729,406

(22) Filed: Dec. 28, 2012

(51) Int. Cl. G06F 17/30

(52) U.S. Cl. CPC G06F 17/3053
USPC 707/726; 707/723; 707/765

(57) ABSTRACT

Methods, systems, and apparatus, including computer programs encoded on a computer storage medium, for using scientific papers in web search are described. A web search system can rank scientific content highly in search results of a query, when the scientific content has been popular in the past but is obscure at query time. The web search system can augment a search query by providing additional search terms when terms in the search query and the additional search terms appeared together in news stories frequently in the past but appear together infrequently at query time.

### BACKGROUND

This specification relates to search technologies.

When a conventional web search system receives a search query, the conventional web search system may produce search results that are broad and shallow. Popular content can be ranked high among the search results and displayed prominently, e.g., on a first search results page. For example, when a search system receives a query “eczema,” the search system can present on a first search result page the most popular content that relates to general knowledge of eczema. On the other hand, deep but relatively obscure content, e.g., scientific papers, even if highly relevant to a user entering the query, may be ranked lower and left out of the first search result page because of the obscurity. For example, a scientific paper on eczema in a scientific journal discussing a specific way of relieving eczema itching, if not in focus of public attention at time of search, may not be presented as a search result on a first result page.

Specialized search systems can be used to search for scientific papers. When a specialized search system receives a search query, the specialized search system often ranks results by criteria such as publication date, author, journal, and title. Thus, if a specialized search system receives a query “eczema,” the specialized search system, like a general web search system, may not present the scientific paper on relieving eczema itching on a first result page, unless the scientific paper ranks high according to one of the ranking criteria of the specialized search system.

### SUMMARY

In general, one aspect of the subject matter described in this specification can be embodied in operations that rank scientific content highly in search results of a query, when the scientific content has been popular in the past but is obscure at query time. The operations include the actions of obtaining, from a scientific index, publication attributes of a published paper; identifying one or more news stories from a collection of electronic documents that each refer to the published paper indexed in the scientific index; determining citation information; determining a popularity score of the published paper based at least in part on the publication attributes and the citation information; and storing an association of the published paper and the popularity score in a database for use in ranking the published paper among search results. The citation information is data characterizing the coverage of the published paper by the one or more news stories. The popularity score indicates an estimated degree of public interest in the published paper. The publication attributes can include one or more attribute terms. Identifying the one or more news stories can include performing a search using one or more of the attribute terms as a search query.

The foregoing and other embodiments can optionally include one or more of the following features. The publication attributes include at least one of an identifier of the published paper, an identifier of an author of the published paper, an identifier of a journal publishing the published paper, a publication date of the published paper, an abstract of the published paper, or one or more keywords associated with the published paper. Determining the popularity score includes determining an influence ranking of the journal and determining the popularity score based at least in part on the influence ranking. The influence ranking of the journal includes an impact factor (IF) of the journal. Determining the popularity score includes determining a quality score for each of the one or more news stories, and determining the popularity score based at least in part on the one or more quality scores for the news stories. Determining the quality score for a corresponding news story includes determining a rating of a source of the corresponding news story and determining the quality score for the corresponding news story based at least in part on the rating. Determining the rating is based at least in part on a popularity ranking of the corresponding source.

In some implementations, determining the popularity score of the published paper includes determining, based at least in part on the citation information, a number of news stories referring to the published paper; and determining the popularity score based at least in part on the number of news stories referring to the published paper. Determining the popularity score of the published paper includes discounting the number of news stories referring to the published paper based at least in part on a release time of each news story referring to the published paper, wherein a more recent release results in a higher popularity score.

In general, another aspect of the subject matter described in this specification can be embodied in operations that augment a query by providing additional query terms when terms in the search query and the additional search terms appeared together in news stories frequently in the past but appear together infrequently at query time. The operations include the actions of receiving a query that includes a query term; identifying a published paper that contains the query term and one or more news stories that each contain the query term and that refer to the published paper; obtaining, from a scientific index, a title of the published paper; and providing, in response to the query, a search augmentation that includes at least a portion of the title.

The foregoing and other embodiments can optionally include one or more of the following features. Identifying the one or more news stories includes performing a search using one or more terms in publication information about the paper as a search query. The publication information includes one or more terms each describing one or more attributes of the published paper. Providing the search augmentation includes at least one of: providing the search augmentation as part of a search suggestion for display on a display device; or providing, to a search system, the search augmentation as an additional query term for use in retrieving search results.

Other embodiments of these aspects include corresponding systems, apparatus, and computer programs recorded on one or more computer storage devices, each configured to perform the actions of the methods. For a system of one or more computers to be configured to perform particular actions means that the system has installed on it software, firmware, hardware, or a combination of them that in operation cause the system to perform the actions. For one or more computer programs to be configured to perform particular actions means that the one or more programs include instructions that, when executed by data processing apparatus, cause the apparatus to perform the actions.

Particular embodiments of the subject matter described in this specification can be implemented to realize one or more of the following advantages. By employing techniques described in this specification, a web search system can add depth to the search results a search engine produces. In addition to providing broad and shallow information, the web search system can provide a deep but relative obscure information item, for example, a scientific paper that is peer reviewed, published, and indexed in a scientific paper database, e.g., PubMed. The web search system can provide links to the scientific papers as search results that supplement search results of a conventional search engine.

By employing the techniques described, a web search system can provide a variety of search suggestions to help a user formulating a search. The search system can receive a user-entered search query the scope of which is limited by the user's scope of knowledge. For example, when a user enters a query “eczema,” the search system can provide a query suggestion “eczema bleach.” To the user, the two terms “eczema” and “bleach” may appear unrelated to one another. However, the search system can determine that the two terms are indeed related to one another if the two terms appeared together in a scientific paper. Accordingly, by employing the techniques described, a web search system can provide the search suggestion “eczema bleach” to the user, even though the search query “eczema bleach” may not be a historically popular query. In addition, the search system can retrieve a first set of search results for search query “eczema bleach” as well as a second set of search results for search query “eczema.” The search system can merge the two sets of search results and provide the merged search results to the user in response to the query “eczema”.

By employing the techniques described, a web search system can extend the effect of the generally short-lived period of time in which a topic or an information item, e.g., a scientific paper, is heavily reported by various news sources. If, for example, a paper relating eczema and bleach has received heightened public attention in the past, e.g., was cited in numerous news stories a year ago, the search system can identify information related to the information item, e.g., the news stories citing the scientific paper, and provide the information item as a search result, even if no heightened interest exists at time of the query. Therefore, past popularity of scientific research can, in effect, be time-shifted to the time of the query.

By employing the techniques described, a web search system can generate relevant queries. For example, when the web search system determines that a query “eczema bleach” is an interesting query based on content related to a popular study in the past, the web search system can obtain current search results for search query “eczema bleach” in addition to content related to the popular study in the past.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTIONS OF DRAWINGS

FIG. 1 is a block diagram providing an overview of techniques of ranking scientific papers based on news stories.

FIG. 2 is a block diagram illustrating an example data structure used in ranking scientific papers based on news stories.

FIG. 3 is a block diagram illustrating example techniques of ranking scientific papers based on news stories.

FIG. 4 is a block diagram illustrating an example application of ranking scientific papers.

FIG. 5 is a graph illustrating an example user interface of a search suggestion produced.

FIG. 6 is a flowchart illustrating an example procedure of ranking scientific papers based on news stories.

FIG. 7 is a flowchart illustrating an example procedure of providing search suggestions.

Like reference numbers and designations in the various drawings indicate like elements.

### DETAILED DESCRIPTION

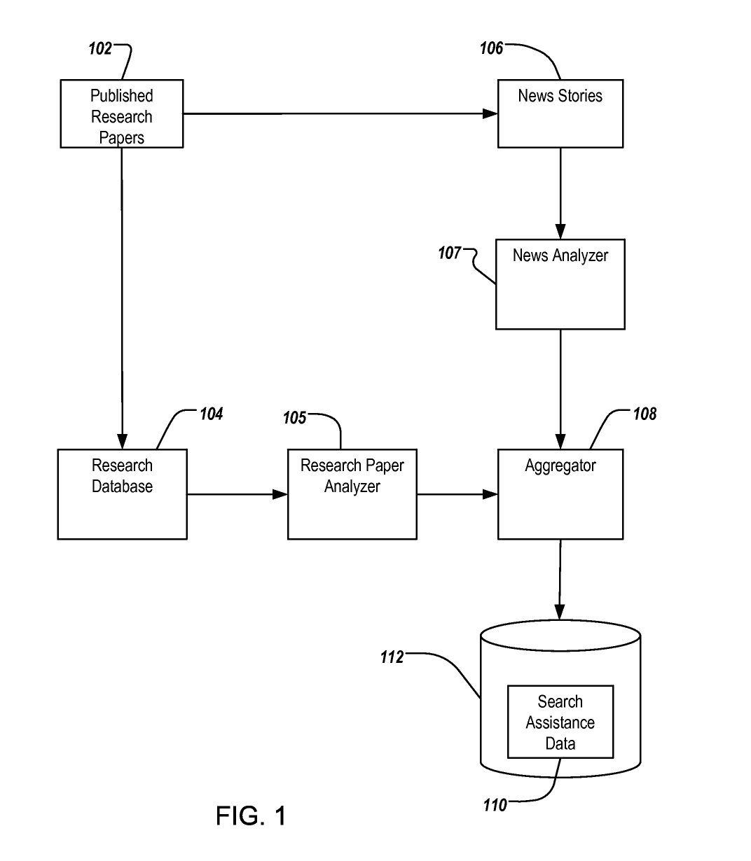

FIG. 1 is a block diagram providing an overview of techniques of ranking scientific papers based on news stories. The techniques can be implemented by a web search system. The web search system includes a server, which can be implemented on one or more computers in one or more locations, configured to access both published research papers 102 and a news story collection 106.

The published research papers 102 include scholarly writings on a scientific, engineering, or other technical subjects that have been published and indexed in a scientific index. For example, a research paper can be an article published in a scientific, research or technical journal. A scientific index is an index external to and separate from an index for general web content. The scientific index can be stored in or made accessible through a research database 104, e.g., the PubMed database provided by the United States National Library of Medicine.

The web search system includes a research paper analyzer 105. The research paper analyzer 105 is a software component of the web search system that is configured to access the scientific index, e.g., by accessing the research database 104, to obtain publication information related to the published research papers 102. The research paper analyzer 105 can obtain one or more of the following items of publication information: a title of a scientific paper, a name of a publication, e.g., a journal, in which the scientific paper is published, a volume number of the publication, a publication date, a name of an author of the scientific paper, a name and address of an institute where the research was conducted, a name of an editor of the publication, a category of the scientific paper, an excerpt, one or more keywords of the scientific paper as provided by an author, editor, reader, or indexer, and an identifier of the scientific paper. The identifier can be, for example, a PubMed Identifier (PMID) of a scientific paper.

The web search system includes a news analyzer 107. The news analyzer 107 is a software component of the web search system that is configured to access a news story collection 106 to obtain citation information, i.e., information about references in news stories to any of the published research papers 102. The news story collection 106 includes data related to one or more news stories. A news story can include any publicly available writing, e.g., a news report, an online social network post, or a personal blog, on any subject, in the form of one or more electronic documents. Each news story in the news story collection 106 can refer to, e.g., cite or describe, one or more scientific papers of the published research papers 102.

The news analyzer 107 can identify news stories referring to a scientific paper by performing a search using one or more items of publication information about the paper as a search query. The news analyzer can obtain citation information from each news story referring to a scientific paper. For example, a news story referring to a scientific paper might include an explicit citation of the paper by a title, an identifier of a journal in which the paper was published, an exact or approximate publication date of the scientific paper, and an author name of the scientific paper. The news analyzer 107 can obtain, from the news story, citation information that includes the title, the identifier, the publication data, and the author name, to the extent this information is present in the news story.

A news story, even when not explicitly citing a scientific paper, can include one or more descriptions, e.g., summaries, of the scientific paper. The news story might include one or more keywords of the scientific paper. For example, a news story that refers to or is based on a paper about treating eczema itching using bleach can include the words “eczema” and “bleach,” which are keywords of the paper. Each news story in the news story collection 106 can be associated with a reporting source, e.g., The New York Times. In some implementations, the citation information can additionally or alternatively include the keywords and reporting source of the news story.

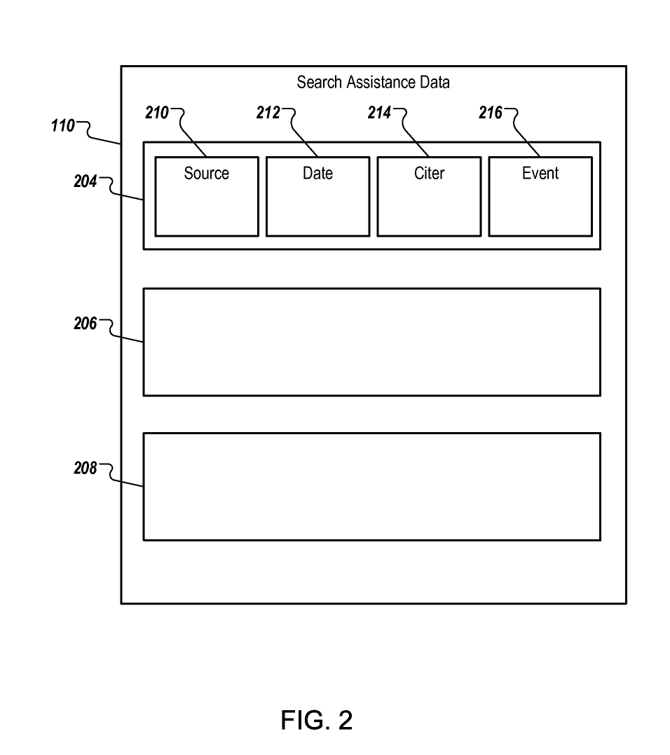

The web search system includes an aggregator 108. The aggregator 108 is a software component of the web search system configured to aggregate publication information obtained from the research database 104 by research paper analyzer 105 and citation information obtained from the news story collection 106 by news analyzer 107. The aggregator 108 generates search assistance data 110 as results of the aggregation. The search assistance data include data for ranking scientific papers and include various description items each describing an aspect of a scientific paper. The search assistance data will be further described below in reference to FIG. 2. The aggregator 108 determines a popularity score for each scientific paper using a weighted combination of values of various description items in the search assistance data 110. Further details on the description items will be provided below in reference to FIG. 2. The aggregator 108 then ranks scientific papers based on the popularity score. To generate search assistance data 110, the aggregator 108 performs a comparison between index information stored in or accessible through the research database 104 and the news stories in the news story collection 106. If a match is found, the aggregator 108 identifies a scientific paper in the published research papers 102 that is (a) indexed in the research database 104 and (b) referred to in the news story collection 106. A reference of a scientific paper in a news story can be identified even when the news story does not explicitly cite the scientific paper.

For example, the aggregator 108 can identify, based on the publication information from the research database 104, a scientific paper, e.g., a paper discussing eczema that is referred to in a news story. The scientific paper can have an identifier, e.g., a PMID, 12345678. The aggregator 108 determines that the paper is referred to in a news story, e.g., a news story published in July 2009 that does not include a direct citation. The determination can be based on a match between the publication information for the publication and the citation information obtained from the news story. For example, the aggregator 108 can identify a match in one or more of an author name, a publication date, a name of research institute, or one or more keywords, e.g., “eczema” and “bleach”. Based on the match, the aggregator 108 can determine the paper having PMID 12345678 is likely to have been referred to in, or the subject of, the news story of July 2009, even if the story does not explicitly cite the paper by the PMID.

The aggregator 108 stores information related to the match as the search assistance data 110. Further details on the content and structure of the search assistance data 110 are described below in reference to FIG. 2.

A web search system can use the search assistance data 110 in various ways. For example, the web search system can use the information in the search assistance data 110 to determine a ranking score of a search result that includes a reference, e.g., a link, to the scientific paper. The web search system can provide a link to the scientific paper, as well as a link to the news story citing the paper, as search results in response to a search query from a user. Accordingly, even if the paper and the news story are not considered by a conventional web search system to be highly popular at the time the query is submitted, the paper and the news story can be displayed to the user as high ranking search results in a search result set using the techniques described in this specification.

In some implementations, the web search system can provide search suggestions based on the search assistance data 110. For example, the search assistance data 110 can include data indicating that one or more keywords are related to one another in the context of a citation, e.g., because they appear together in that context. This aspect will be disclosed in further detail below. Upon receiving a search query including one keyword in the search assistance data 110, the web search system can provide a related keyword for a search suggestion.

For example, by virtue of being used together often as keywords in a frequently cited scientific paper and as terms in news stories that refer to the scientific paper, a first word, e.g., “eczema”, and a second word, e.g., “bleaching”, are designated in the search assistance data 110 as being related to one another. The first keyword and second keyword can be related in the search assistance data 110 even when the first keyword and second keyword do not frequently appear together in user-entered search queries. Upon receiving a search query including the first keyword “eczema,” the web search system can provide a search suggestion that includes the second keyword, based on the relationship in the search assistance data 110. Accordingly, the web search system can provide the search suggestion “eczema bleach” for display on a user device.

The web search system stores the search assistance data 110 in a database 112. The aggregator 108 can update the search assistance data 110 from time to time. The web search system can perform operations of updating the search assistance data 110 separately from operations of providing search results in response to a query. Further features of the search assistance data 110 will be described below in reference to FIG. 2.

FIG. 2 is a block diagram illustrating an example data structure used in ranking scientific papers based on news stories. The search assistance data 110 are stored in a data store as one or more data records. FIG. 2 shows example data records 204, 206, and 208.

A data record includes a set of description items, each of which describes an aspect of a source of a scientific paper, an aspect of a citer, e.g., a source of a news story that refers to or is based on the scientific paper, or an aspect of a reference to the scientific paper in a news story. The description items are organized in information groups 210, 212, 214, and 216. Each of the information groups 210, 212, 214, and 216 is a group of one or more description items. The features of each information group are described below.

Source information group 210 includes one or more description items, each of which describing an aspect of a source of a scientific paper. The description items can include, for example, an identifier of the scientific paper and an identifier of a publication publishing the scientific paper. The identifier of the scientific paper can be an identification number of the scientific paper, e.g., a PMID. The identifier of the publication can be a name, e.g., “Pediatrics,” of the publication, or an identification number of the publication. The identification number can be an international standard book number (ISBN) or an international standard serial number (ISSN) or other standard number of the publication. If the publication is a journal, the identifier of the publication can include a volume number of a journal. In addition, the description items in the source information group 210 can include a publication date. The description items in the source information group 210 can be retrieved from the publication information obtained by the research paper analyzer 105.

Date information group 212 includes one or more description items, each of which indicates a referring date of the scientific paper. A referring date is a date on which a news story that refers to or is based on the scientific paper is made available to the public. For example, the date information group 212 includes a referring date of Jul. 9, 2009, the date on which a New York Times news story that refers to or is based on the scientific paper is first made available to the public. The description items in the data information group 212 can be retrieved from the citation information.

Citer information group 214 includes one or more description items, each of which describes an aspect of a citer of the published research. A citer is a publisher of a news story that refers to or is based on the scientific paper, explicitly, e.g., by name or PMID, or implicitly, e.g., by author name, publication date, and description. A citer can include, for example, a news source, e.g., a website. A description item in the citer information group 214 can include a citer name, e.g., “New York Times,” or a citer web site, e.g., “nytimes.com,” or a citer identification number. The description items in the citer information group 214 can be retrieved from the citation information.

Event information group 216 includes one or more description items, each describing an aspect of the reference to a scientific paper by a news story. In some implementations, the description items in the event information group 216 include keywords that link the published research work and the news story. For example, the event information group 216 can include the keywords “eczema” and “bleach” that serve as a link between various news stories and a published scientific paper discussing treatment of eczema itching with bleach.

In some implementations, the keywords of a scientific paper are further selected from the news story based on a weight. The weight of a keyword can correspond to a number of occurrences of terms appearing in the news story citing the scientific paper. A keyword is selected and stored in the event information group 216 if the weight of the keyword exceeds a threshold. The description items in the event information group 216 can be obtained from a combination of the publication information obtained by the research paper analyzer 105 and the citation information obtained by the news analyzer 107.

Scientific papers and data records in the search assistance data 110 can have a one-to-many relationship. Each scientific paper can correspond to one or more data records.

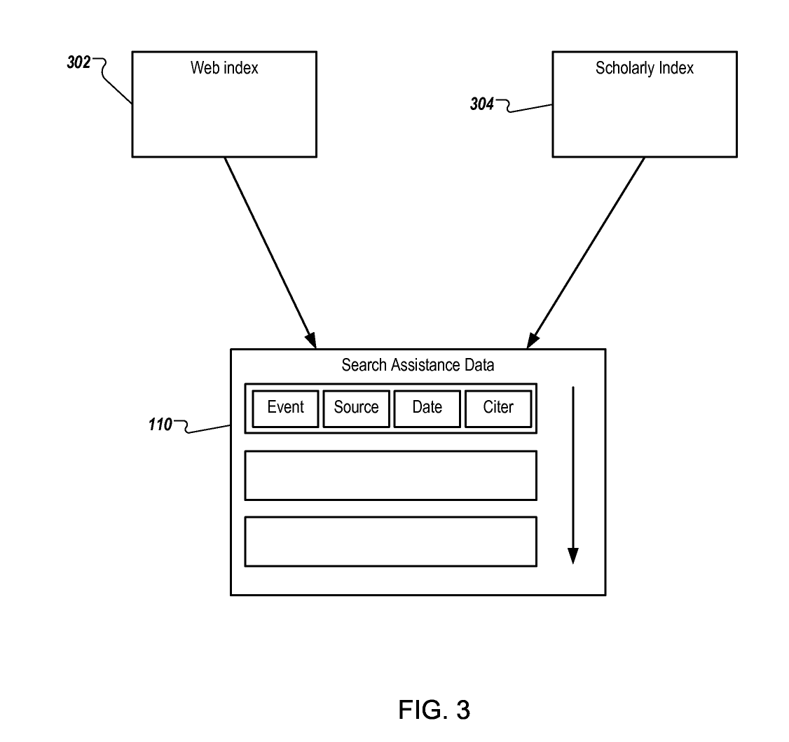

FIG. 3 is a block diagram illustrating example techniques of ranking scientific papers based on news stories. A web search system filters data records 204, 206, and 208 of the search assistance data 110. The web search system can then determine a popularity score for each of the scientific papers using the filtered data records. The popularity score of a scientific paper can be used as an estimated degree of interest of the general public in the scientific paper, rather than a degree of interest of a specific scientific community in the scientific paper. The web search system can rank the scientific papers and provide links to the scientific papers as search results according the estimated degree of interest of the general public in each scientific paper.

The web search system filters the data records to reduce the amount of data that needs to be stored. Published research work and news stories citing the published research work can include a vast amount of data. The web search system selects the most useful information from the data through filtering and ranking. The web search system filters the published research work and the news stories based on a number of citations and one or more temporal parameters.

In general, in filtering the data records, data records relating to a scientific paper that has been cited more times are more likely to be kept than data records relating to a scientific paper that has been cited fewer times. A data record that corresponds to scientific paper that has been cited in news stories for over a threshold number of times is retained. Data records that correspond to a scientific paper that have been cited in news stories for fewer than the threshold number of times are omitted from the search assistance data 110.

The number of the citations of a scientific paper can be a number of news stories referring to the scientific paper. In some implementations, the number of news stories can be weight-adjusted according to an amount of details of the scientific paper included in each news story. For example, if a news story referring to a scientific paper contains a citation of the scientific paper that conforms to a standard citation format, or provides a detailed analysis of the scientific paper, the weight can be greater, e.g., one. By comparison, if the news story only vaguely refers to or is based on the scientific paper by including an approximate publication date of the scientific paper and a few keywords in the scientific paper, the weight can be less, e.g., 0.5.

In addition, filtering the data records can be based at least in part on temporal parameters. In general, data records relating to a scientific paper that has been cited more recently is more likely to be kept than data records relating to a scientific paper that has been cited further back in time. In some implementations, the web search system filters the data records of the search assistance data 110 using a weighted combination of a number of citations and a temporal parameter. A recent citation is given more weight than an old citation. Thus, if a first scientific paper was referred to in a distant past, and a second scientific paper was referred to recently, the web search system is more likely to include data records associated with the second scientific paper in the search assistance data 110, if both papers were referred to the same number of times.

After filtering the data records, the web search system determines a popularity score for each of the scientific papers based on the filtered data records. The web search system determines the popularity score of each scientific paper based on one or more of the following factors: a weighted number of citations of the scientific paper, a quality score of each news story citing the scientific paper, or a quality score of the scientific paper. The web search system determines the weighted number of citations of the scientific paper using filtered data records in the search assistance data 110, as described above. The web search system determines the quality scores using the operations described below. The quality score of the news story and the quality score of the scientific paper may or may not correspond to the newsworthiness of the news story or the scientific merit of the scientific paper.

The web search system determines the quality score of a news story based on information obtained from a web index 302. The web index 302 includes an index to source information on source of each news story and an index to page view information of each news story citing the scientific paper. The source of a news story that refers to or is based on a scientific paper is a citer of the scientific paper.

The web search system can determine the quality score of a news story based at least in part on a rating score of a citer obtained from the source information. The web search system can determine the rating score based on a score measuring popularity rating of the citer. For example, the source information can include an audience size, e.g., web access volume, of a citer. The web search system can give a citer having a bigger audience a higher popularity rating than a source having a smaller audience. Accordingly, a first news story whose source has a bigger audience can have a higher quality score than a second news story whose source has a smaller audience. The source information can include a reach area. The web search system can give a worldwide news source a higher popularity rating than the web search system gives to a regional or local news source; however, in the region or locality covered by the regional or local news source, the regional or local news source can have a higher rating than the worldwide news source.

Additionally or alternatively, the web search system can determine the quality score of a news story based on page view number of the news story. The web search system can give a higher quality score to a first news story that refers to or is based on a scientific paper the web search system gives to a second news story that refers to or is based on the scientific paper if the first news story, when displayed as web page, has more page views or more user comments than the second news story has. The web search system can determine the popularity quality score of a news story based on a weighted combination of the rating score of the citer and the page view number.

The web search system determines a quality score of a scientific paper using information obtained from a scholarly index 304. The scholarly index 304 can be a part of the scientific index as described above, or an index different from the scientific index. The scholarly index 304 can include information on influence of the scientific paper in a scientific community. Additionally, the information can include rankings of influence of the publisher of the scientific paper. Such information can include, for example, a journal's impact factor (IF). The scholarly index 304 can include, for example, Science Citation Index (SCI). The information can be encoded in a markup language that includes metadata of the information.

The web search system can use a weighted combination of the quality score of the scientific paper and the quality score of each news story citing the scientific paper to determine the popularity score of each of the scientific papers. The web search system can determine a ranking of the scientific paper based on the quality score.

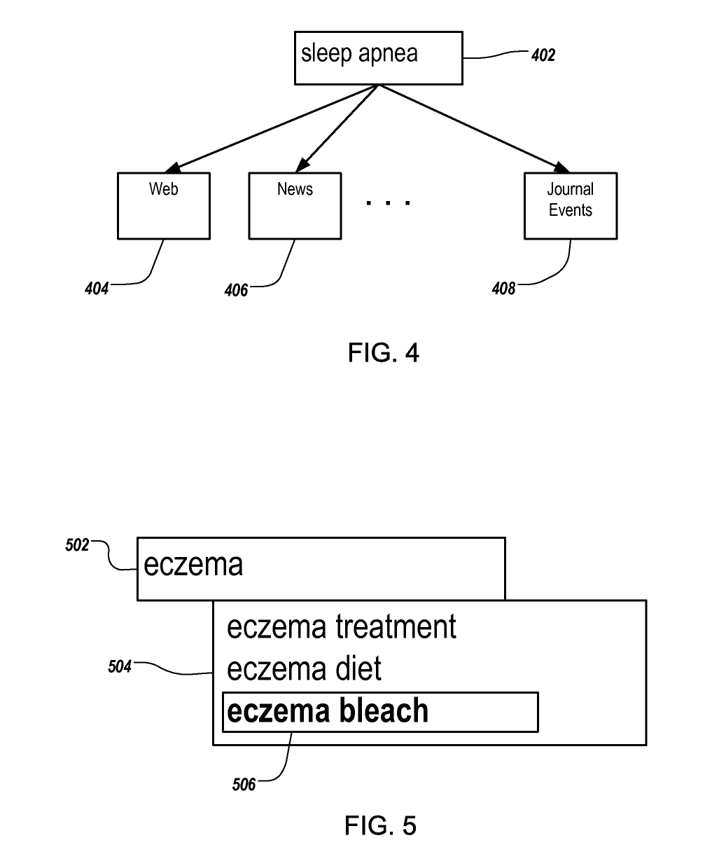

FIG. 4 is a block diagram illustrating an example application of ranking scientific papers. A user interface of a web search system includes a search box 402. The search box 402 is a user interface item configured to be displayed at a user device and receive search queries from a user. The web search system provides multiple search options, each search option corresponding to a set of parameters for narrowing the search to a specified area. For example, the web search system can provide web search option 404 for searching web content in general. The web search system can provide news search option 406 for searching news posted on the web. The web search system provides journal event search option 408. If the journal event search option 408 is selected, the web search system performs a search using the search assistance data 110, as described above in reference to FIGS. 1-3. In some implementations, search results produced using the search assistance data 110 are combined with search results from other sources to provide a user with a unified search result set. For example, if the search system receives a query “eczema,” the search system can combine search results from a conventional web search engine with search results generated based on the search assistance data 110. A search result generated based on the search assistance data 110, e.g., a reference to a scientific paper about eczema and bleach, can be positioned among other search results according to the corresponding popularity rating. For example, if the popularity rating is high, the search result generated based on the search assistance data 110 can be placed at or near the top of the search result list.

FIG. 5 is a graph illustrating an example user interface of a search suggestion. In addition to using information in the search assistance data 110 to provide references to scientific papers as search results, a web search system can use the search assistance data 110 to provide search suggestions. When the web search system receives a user query including one or more query terms, the web search system can provide for display the user query one or more additional query terms as a query suggestion. For example, the web search system receives, in a search box 502, a search query “eczema.” In a search suggestion box 504, the system provides search suggestions “eczema treatment” and “eczema diet” generated using conventional technology

In addition, the web search system uses the search query “eczema” to identify a scientific paper that (a) relates to eczema and (b) has a popularity score that exceeds a threshold, indicating that the popularity of the scientific paper is sufficiently high or was sufficiently high in the past. For example, the web search system identifies a highly popular scientific paper that relates to eczema. Using the search assistance data 110, the web search system can identify one or more keywords. In some implementations, the web search system can identify the keywords from content of the scientific paper, from a title of the scientific paper, or from a list of keywords provided by an author, editor, or indexer of the scientific paper. In some implementations, the web search system can identify the keywords from an event information group, e.g., information group 216 of FIG. 2, of a data record of the search assistance data 110. In this example, the web search system identifies a keyword “bleach” from the content of a scientific paper based on a number of occurrences the keyword “bleach” appears in the scientific paper. The web search system then provides the keyword “bleach” as an additional term in the search suggestion 506. The search suggestion 506 can be displayed with other search suggestions in the search suggestion box 504.

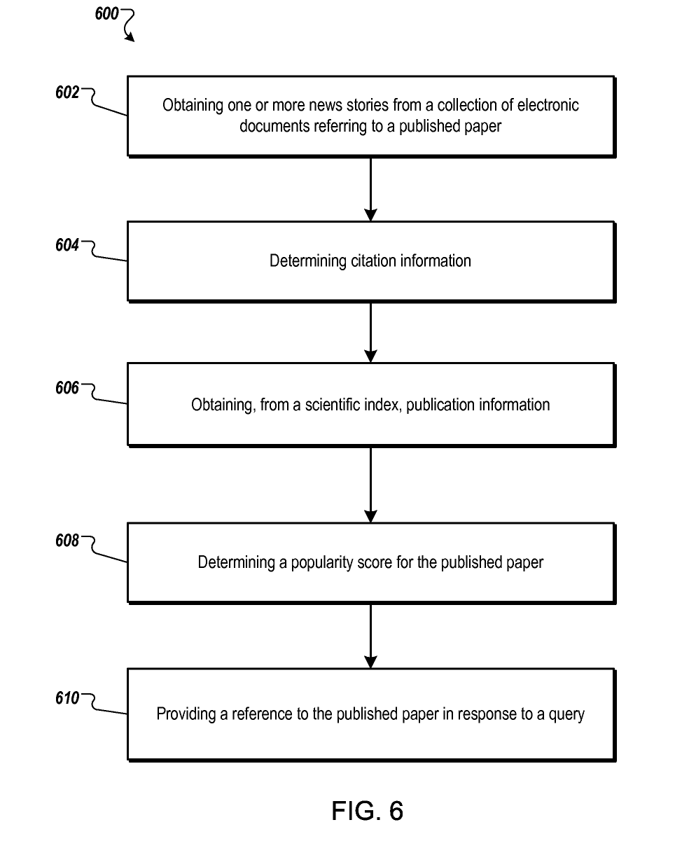

FIG. 6 is a flowchart illustrating an example procedure 600 of ranking scientific papers based on news stories. A web search system implemented on one or more computers is configured to execute the example procedure 600. The web search system obtains (602) one or more news stories from a collection of electronic documents. Each of the one or more news stories refers to a published scientific paper indexed in a scientific index.

The web search system determines (604) citation information referring to the published scientific paper. The citation information includes one or more text items that appear in the news stories. The text items are related to the published scientific paper. The text items can include titles, authors, or descriptions of the published scientific paper.

The web search system obtains (606), from the scientific index, publication information about the published scientific paper. The publication information includes one or more characteristics that, according to the scientific index, are associated with the published scientific paper. The publication information can include one or more of, for example, an identifier of the published scientific paper, an identifier of an author of the published scientific paper, an identifier of a journal publishing the published scientific paper, a publication date of the published scientific paper, an abstract of the published scientific paper, or one or more keywords associated with the published scientific paper.

The web search system determines (608) a popularity score for the published scientific paper based at least in part on the publication information and the citation information. The popularity score indicates an estimated degree of public interest in the published scientific paper. Determining the popularity score can include determining an influence ranking of a journal, e.g., a scientific journal, in which the published scientific paper had been published. The influence ranking of the journal can include an impact factor (IF) of the journal. The web search system can determine the popularity score based on the influence ranking.

In some implementations, determining the popularity score can include using a quality score for each of the one or more news stories. The web search system can determine the popularity score based at least in part on the one or more quality scores for the news stories. The quality score for the referring document can be based in whole or in part on a quality score associated with the source by the web search system. The web search system can determine the quality score of the source based on a popularity ranking of the source.

In some implementations, determining a popularity score of a published scientific paper can include, based on the citation information, determining how many news stories refer to or are based on the published scientific paper. The system can determine the popularity score based at least in part on the number of news stories referencing the published scientific paper. The system can discount the number of news stories by applying a decay factor to an age of each referring document, so that old news stories count for less than one.

At query time, upon receiving a search query, the web search system provides (610) a reference to the published scientific paper as a search result that satisfies a search query in response to the search query. The reference is placed in an ordered list of search results according to the popularity score. A relative position between the reference and other search results can correspond to the popularity score, where a higher popularity score corresponds to a higher position. Without accounting for the popularity score, the web search system might not have presented the reference in the ordered list when the published scientific paper is an electronic document the reference to which, according to a web index, is not to be included in the list of search results.

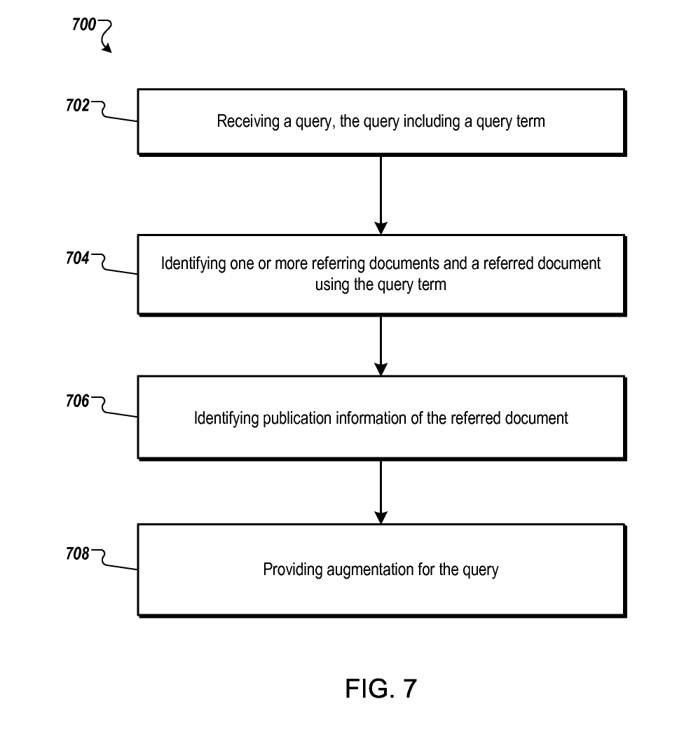

FIG. 7 is a flowchart illustrating an example procedure 700 of providing search suggestions. A web search system implemented on one or more computers is configured to execute the example procedure 700. The web search system receives (702) a query. The query includes a query term. The query term can be a portion of a word, a word, or multiple words.

The web search system identifies (704) one or more news stories and a published scientific paper using the query term. The news stories can be news stories. The published scientific paper can include a scientific paper. The system determines that each of the one or more news stories refers to or is based on the published scientific paper. Each news story can refer to published scientific paper by explicit citation or by providing information relating to the published scientific paper.

The web search system identifies (706) publication information of the published scientific paper. The publication information includes one or more text items indicating characteristics of the published scientific paper. For example, the publication information can include at least one of a title of the published scientific paper, an identifier of an author of the published scientific paper, an identifier of a journal publishing the published scientific paper, a publication date of the published scientific paper, an abstract of the published scientific paper, or one or more keywords of the published scientific paper as provided by an author or editor of the scientific paper.

The system provides (708) at least a portion the text item in the publication information of the published scientific paper as augmentation for the query. The portion of the text item in the publication information can include a portion of a title, abstract, excerpt, or keyword of the published scientific paper. For example, when the query term is “eczema,” the system can provide as part of a search suggestion a term “bleach” that was found in the publication information. The system can provide the term for display in a drop-down box in a display area of a user device. In some implementations, the system can generate a new search query including the terms “eczema” and the augmentation “bleach” and retrieve results of query “eczema” and results for query “eczema bleach.” The system can merge the two sets of results and provide the merged sets to a user in response to the user's query “eczema”.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. For example, the subject matter is described in context of scientific papers. The subject matter can apply to other indexed work that adds depth aspect to a search. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A method performed by one or more computers, comprising:
obtaining, from a scientific index, publication attributes of a published paper;
identifying one or more news stories from a collection of electronic documents that each refer to the published paper indexed in the scientific index;
determining citation information, the citation information being data characterizing coverage of the published paper by the one or more news stories;
determining a popularity score of the published paper based at least in part on the publication attributes and the citation information, the popularity score indicating an estimated degree of public interest in the published paper; and
storing an association of the published paper and the popularity score in a database for use in ranking the published paper among search results.

2. The method of claim 1, wherein the publication attributes include at least one of an identifier of the published paper, an identifier of an author of the published paper, an identifier of a journal publishing the published paper, a publication date of the published paper, an abstract of the published paper, or one or more keywords associated with the published paper.

3. The method of claim 2, wherein determining the popularity score comprises:
determining an influence ranking of the journal, the influence ranking of the journal including an impact factor (IF) of the journal; and
determining the popularity score based at least in part on the influence ranking.

4. The method of claim 1, wherein determining the popularity score comprises:
determining a quality score for each of the one or more news stories; and
determining the popularity score based at least in part on the one or more quality scores for the news stories.

5. The method of claim 4, wherein determining the quality score for a corresponding news story comprises:
determining a rating of a source of the corresponding news story; and
determining the quality score for the corresponding news story based at least in part on the rating.

6. The method of claim 5, wherein determining the rating comprises determining the rating based at least in part on a popularity ranking of the corresponding source.

7. The method of claim 1, wherein determining the popularity score of the published paper comprises:
determining, based at least in part on the citation information, a number of news stories referring to the published paper; and
determining the popularity score based at least in part on the number of news stories referring to the published paper.

8. The method of claim 7, wherein determining the popularity score of the published paper includes discounting the number of news stories referring to the published paper based at least in part on a release time of each news story referring to the published paper, wherein a more recent release results in a higher popularity score.

9. The method of claim 1, wherein:
the publication attributes include one or more attribute terms; and
identifying the one or more news stories comprises performing a search using one or more of the attribute terms as a search query.

10. A method performed by one or more computers, the method comprising:
receiving a query, the query including a query term;
identifying a published paper that contains the query term and one or more news stories that each contain the query term and that refer to the published paper;
obtaining, from a scientific index, a title of the published paper; and
providing, in response to the query, a search augmentation that includes at least a portion of the title.

11. The method of claim 10, wherein identifying the one or more news stories comprises performing a search using one or more terms in publication information about the paper as a search query, the publication information comprising one or more terms each describing one or more attributes of the published paper.

12. The method of claim 10, wherein providing the search augmentation comprises at least one of:
providing the search augmentation as part of a search suggestion for display on a display device; or
providing the search augmentation as an additional query term for use in retrieving search results.

13. A non-transitory storage device storing instructions operable to cause one or more computers to perform operations comprising:
obtaining, from a scientific index, publication attributes of a published paper;
identifying one or more news stories from a collection of electronic documents that each refer to the published paper indexed in the scientific index;
determining citation information, the citation information being data characterizing coverage of the published paper by the one or more news stories;
determining a popularity score of the published paper based at least in part on the publication attributes and the citation information, the popularity score indicating an estimated degree of public interest in the published paper; and
storing an association of the published paper and the popularity score in a database for use in ranking the published paper among search results.

14. The non-transitory storage device of claim 13, wherein the publication attributes include at least one of an identifier of the published paper, an identifier of an author of the published paper, an identifier of a journal publishing the published paper, a publication date of the published paper, an abstract of the published paper, or one or more keywords associated with the published paper.

15. The non-transitory storage device of claim 14, wherein determining the popularity score comprises:
determining an influence ranking of the journal, the influence ranking of the journal including an impact factor (IF) of the journal; and
determining the popularity score based at least in part on the influence ranking.

16. The non-transitory storage device of claim 13, wherein determining the popularity score comprises:
determining a quality score for each of the one or more news stories; and
determining the popularity score based at least in part on the one or more quality scores for the news stories.

17. The non-transitory storage device of claim 16, wherein determining the quality score for a corresponding news story comprises:
determining a rating of a source of the corresponding news story; and
determining the quality score for the corresponding news story based at least in part on the rating.

18. The non-transitory storage device of claim 17, wherein determining the rating comprises determining the rating based at least in part on a popularity ranking of the corresponding source.

19. The non-transitory storage device of claim 13, wherein determining the popularity score of the published paper comprises:
determining, based at least in part on the citation information, a number of news stories referring to the published paper; and
determining the popularity score based at least in part on the number of news stories referring to the published paper.

20. The non-transitory storage device of claim 19, wherein determining the popularity score of the published paper includes discounting the number of news stories referring to the published paper based at least in part on a release time of each news story referring to the published paper, wherein a more recent release results in a higher popularity score.

21. The non-transitory storage device of claim 13, wherein:
the publication attributes include one or more attribute terms; and
identifying the one or more news stories comprises performing a search using one or more of the attribute terms as a search query.

22. A non-transitory storage device storing instructions operable to cause one or more computers to perform operations comprising:
receiving a query, the query including a query term;
identifying a published paper that contains the query term and one or more news stories that each contain the query term and that refer to the published paper;
obtaining, from a scientific index, a title of the published paper; and
providing, in response to the query, a search augmentation that includes at least a portion of the title.

23. The non-transitory storage device of claim 22, wherein identifying the one or more news stories comprises performing a search using one or more terms in publication information about the paper as a search query, the publication information comprising one or more terms each describing one or more attributes of the published paper.

24. The non-transitory storage device of claim 22, wherein providing the search augmentation comprises at least one of:
providing the search augmentation as part of a search suggestion; for display on a display device or
providing the search augmentation as an additional query term for use in retrieving search results.

25. A system comprising:
one or more computers; and
a non-transitory storage device storing instructions operable to cause the one or more computers to perform operations comprising:
obtaining, from a scientific index, publication attributes of a published paper;
identifying one or more news stories from a collection of electronic documents that each refer to the published paper indexed in the scientific index;
determining citation information, the citation information being data characterizing coverage of the published paper by the one or more news stories;
determining a popularity score of the published paper based at least in part on the publication attributes and the citation information, the popularity score indicating an estimated degree of public interest in the published paper; and
storing an association of the published paper and the popularity score in a database for use in ranking the published paper among search results.

26. The system of claim 25, wherein the publication attributes include at least one of an identifier of the published paper, an identifier of an author of the published paper, an identifier of a journal publishing the published paper, a publication date of the published paper, an abstract of the published paper, or one or more keywords associated with the published paper.

27. The system of claim 26, wherein determining the popularity score comprises:
determining an influence ranking of the journal, the influence ranking of the journal including an impact factor (IF) of the journal; and
determining the popularity score based at least in part on the influence ranking.

28. The system of claim 25, wherein determining the popularity score comprises:
determining a quality score for each of the one or more news stories; and
determining the popularity score based at least in part on the one or more quality scores for the news stories.

29. The system of claim 28, wherein determining the quality score for a corresponding news story comprises:
determining a rating of a source of the corresponding news story; and
determining the quality score for the corresponding news story based at least in part on the rating.

30. The system of claim 29, wherein determining the rating comprises determining the rating based at least in part on a popularity ranking of the corresponding source.

31. The system of claim 25, wherein determining the popularity score of the published paper comprises:
determining, based at least in part on the citation information, a number of news stories referring to the published paper; and
determining the popularity score based at least in part on the number of news stories referring to the published paper.

32. The system of claim 31, wherein determining the popularity score of the published paper includes discounting the number of news stories referring to the published paper based at least in part on a release time of each news story referring to the published paper, wherein a more recent release results in a higher popularity score.

33. The system of claim 25, wherein:
the publication attributes include one or more attribute terms; and
identifying the one or more news stories comprises performing a search using one or more of the attribute terms as a search query.

34. A system comprising:
one or more computers; and
a non-transitory storage device storing instructions operable to cause the one or more computers to perform operations comprising:
receiving a query, the query including a query term;
identifying a published paper that contains the query term and one or more news stories that each contain the query term and that refer to the published paper;
obtaining, from a scientific index, a title of the published paper; and
providing, in response to the query, a search augmentation that includes at least a portion of the title.

35. The system of claim 34, wherein identifying the one or more news stories comprises performing a search using one or more terms in publication information about the paper as a search query, the publication information comprising one or more terms each describing one or more attributes of the published paper.

36. The system of claim 34, wherein providing the search augmentation comprises at least one of:
providing the search augmentation as part of a search suggestion for display on a display device; or
providing the search augmentation as an additional query term for use in retrieving search results.
